(19) United States
(12) Patent Application Publication
(10) Pub. No.: US 2025/0214171 A1
(43) Pub. Date: Jul. 3, 2025

(54) PROCESS FOR DEPOSITION OF METAL CLADDING ONTO A HOLLOW METAL SUBSTRATE AT ULTRA-HIGH DEPOSITION RATES

(71) Applicant: AUGUSTINE TECHNOLOGIES LLC, FARMINGTON HILLS, MI (US)

(72) Inventor: Russell V. HUGHES, PLYMOUTH, MI (US)

(21) Appl. No.: 19/005,434

(22) Filed: Dec. 30, 2024

Related U.S. Application Data
(60) Provisional application No. 63/616,531, filed on Dec. 30, 2023.

(51) Int. Cl. B23K 10/02; B23K 37/003

(52) U.S. Cl. CPC B23K 10/027; B23K 37/003

(57) ABSTRACT

A cladding process for depositing metal cladding onto a hollow metal substrate at ultra-high deposition rates, including: applying softer metal cladding as at least one annular band around a circumferential periphery of the hollow metal substrate using a plasma-arc welding device; circulating a liquid heat transfer medium through an interior space of the harder metal, hollow metal substrate such that an outer surface of the substrate to which metal cladding is to be applied is maintained at desired temperatures throughout the cladding applying step; and controlling temperature of the circulating liquid heat transfer medium to be within a predetermined temperature range. The hollow metal substrate is formed of a harder metal than the metal cladding.

### BACKGROUND OF THE INVENTION

### Field of the Invention

The present invention relates to a process for depositing metal cladding onto a hollow metal substrate at ultra-high deposition rates while maintaining high quality. More particularly, the present invention relates to such a process wherein cladding metal is deposited using a higher speed manufacturing technique, such as plasma-arc, additive manufacturing, while temperature of the hollow metal substrate is controlled using a liquid medium based temperature control arrangement such that an outer surface of the substrate to which metal cladding is to be applied is maintained at appropriate temperatures throughout the cladding process to permit ultra-high deposition rates of the metal cladding in spite of the great amount of heat generated by the higher speed manufacturing technique, such that a very high production rate of high quality metal-clad, hollow metal substrates can be achieved.

### Description of the Background Art

In the production of heavy-caliber munitions it is often the case that a steel (by example) casing, generally described as a “shell”, of the heavy-caliber munitions is clad with a metal material around the basal periphery of the casing that is significantly softer than the steel forming the casing. The softer metal material of the cladding is commonly termed a “driving band”, or “driving bands” if more than one in number. The purpose of the driving band(s) is to engage intimately with a bore of the barrel, of, for example, a Howitzer or other armament such as a Tank that fires the heavy-caliber munitions. Such intimate engagement must be sufficient to create a seal between the shell and barrel bore to ensure that propellant detonated in the breach of the barrel for ejecting the heavy-caliber munitions develops the maximum possible pressure, forcing the shell to exit the barrel at very high velocity, which in turn maximizes the range of the heavy-caliber munitions and the destructive power of the shell on impact due to a combination of detonation of internal explosive media contained in the heavy-caliber munitions and the kinetic energy applied to the shell by virtue of its velocity.

The metal material of the driving band must be soft enough to deform to the dimensions and internal form of the barrel bore, whether rifled or smooth, without damaging said barrel. Traditionally, softer metal materials such as copper, lead or bronze have proven to be effective metals for forming the driving band.

Such driving band(s) can be attached or fitted to the shell casing by, for example, shrink fitting, but a more robust and reliable attachment can be made by depositing the band(s) from wire-based or powder-based stock through the application of a number of different heat sources, such as lasers, gas-metal arc welding (GMAW) or gas-tungsten arc welding (GTAW). These depositing processes are generally classified as “cladding techniques” and are very well known across a very broad industrial spectrum. Presently, GMAW is the most commonly used method for attaching the cladding as driving band(s) in production of heavy-caliber munitions as it permits relatively high rates of deposition, e.g., 6 lbs/hr, is relatively simple to set up and operate the relevant equipment, and can achieve adequate quality in depositing the aforementioned conventional driving band metal materials.

### An Issue Facing the Munitions Industry

In the quest for ever-more effective capabilities from heavy-caliber munitions, more potent propellants and longer barrels have been found to add significantly to the discharge velocity and hence the range of munitions shells. However, the higher barrel pressures and greater amount of engagement of the shell with the barrel, e.g., a “long barrel” may be 100 inches or more longer in length than a conventional one, has led to failures in the driving bands made with the conventional softer metal materials, e.g., copper, bronze, lead etc. For example, the driving bands may detach from the shell casings, in which case, pressure is lost behind the shell and discharge velocity of the shell decreases rapidly. Worse, the barrel may sustain damage due to direct contact with the steel shell casings rather than the “soft” driving bands.

It has been found that by substituting nickel or nickel alloys for the more conventional metal materials and depositing it by GMAW welding, the performance of the driving band can be greatly improved. However, GMAW welding deposition of the nickel and nickel alloys is fraught with challenges, including variable dilution with the steel casing, occurrence of lack-of-fusion defects, deposit porosity and inefficient use of the strategic and costly nickel materials due to losses from spatter. Sometimes, to meet established dilution criteria an excessively thick deposit may be required, increasing material costs significantly. Presently, deposition rates involving nickel and nickel alloys are limited to those achievable with the conventional cladding metal materials, e.g., around 6 lbs/hr. Based on this, typical heavy-caliber munitions such as a 155 mm caliber shell requires about 3 lbs of nickel or a nickel alloy to be deposited around the base of the shell, and overall productivity of the heavy-caliber munitions remains relatively low. Conventional laser-based cladding techniques are also known to experience difficulties in the production of heavy-caliber munitions.

Adding to the problem of low productivity rates, there is currently a significantly increased demand for heavy-caliber munitions base on various military conflicts and wars around the world. The existing techniques for manufacturing the heavy-caliber munitions are not capable of meeting the increased demand.

Hence there remains a need in the art for a process for depositing metal cladding onto a hollow metal substrate at much higher deposition rates than currently possible, while maintaining high quality of the metal clad hollow metal substrates.

### SUMMARY OF THE INVENTION

It is an object of the invention to satisfy the discussed need.

According to one aspect of the present invention, the inventor has conceived of and developed a Plasma-Arc based process for depositing metal cladding materials onto hollow metal substrates at ultra-high metal deposition rates.

Some conventional apparatus for performing Plasma-Arc based techniques and some conventional Plasma-Arc based processes are disclosed in U.S. Pat. Nos. 6,215,088, 6,215,089, 6,225,743 and 6,353,200. Conventionally, the Plasma-Arc based process manufacturing technique has thus far been primarily for application in the arena known as 3D printing or Additive Manufacturing. The Plasma-Arc based process has been shown capable of depositing a wide variety of metals from wire feedstock, e.g., stainless steel, titanium, inconel, tantalum and nickel to name but a few, at rates of 25 lbs/hr and above. As will be appreciated, such rate is four times or more higher than the GMAW process can typically achieve. Additionally, transfer of the metal, such as nickel, to the substrate, such as steel, is quiescent inasmuch that there is no spatter and the meltpool remains in a steady state condition. GMAW welding deposition techniques do not provide these desirable characteristics.

Given the deposition rates achievable with Plasma-Arc based techniques, use of the Plasma-Arc based techniques for the deposition of softer metal cladding as driving bands onto hollow steel shells could theoretically result in a four-fold increase or more in productivity of the heavy-caliber munitions compared to the conventional GMAW techniques, while the Plasma-Arc based techniques also could advantageously reduce the amounts of the softer metals, such as nickel, used in depositing the cladding on a given hollow substrate.

### Considerations

However, the Plasma-Arc based techniques for depositing the metal cladding at higher rates also generates a great amount of heat that must be must be dealt with to avoid quality problems with the metal clad shells being produced. For example, a typical heavy-caliber munitions to be discharged from a Howitzer or other armament includes a 155 mm caliber shell casing, which is a hollow forged part typically made from ASTM grade 4140 steel, though many other grades of steel could be used. The American Welding Society (AWS) weld standards recommend, but do not require, that before welding or depositing metal on to 4140 steel, the steel should be pre-heated to between 200 and 600° F. such that subsequent cooling rates of the weld/deposit are slowed to a level whereby the risk of cracking of the steel is mitigated. For example, casings of 4140 steel can be preheated in an oven to the requisite temperature and then rapidly fixtured in a welding device that applies the driving band and the deposit made while maintaining the correct degree of preheat. Other methods can be used for preheating the 4140 steel casings as well.

The inventor has determined that: in transitioning from the conventional GMAW techniques to the Plasma-Arc based technique for achieving the much higher cladding rate than is possible with the GMAW techniques, very large amounts of energy are directed into the shell casing that can result in overheating of the shell; and the temperature of the shell casing needs to be kept stable throughout the cladding operation if optimum results and reliable production are to be sustained. Higher preheating temperatures for the shells could be used, but excessive preheating can increase dilution of the nickel or other cladding metal with the steel, potentially exceeding specified levels. Also, high preheating can cause excessive surface oxidation on the shell (scaling) which can impair adhesion of the nickel or other cladding metal to the steel shell and even create internal defects in the deposited metal. In summation, too little preheat can be an issue and so can too much.

### The Solution

The present inventor has carefully studied this, and has invented a liquid medium based temperature control arrangement that can be used as part of a Plasma-Arc based deposition system to maintain an outer surface of the hollow substrate to which metal cladding is applied at appropriate temperatures throughout the cladding process to thereby permit ultra-high deposition rates of the metal cladding in spite of the great amount of heat generated by the Plasma-Arc based process manufacturing techniques.

According to an exemplary embodiment of the present invention, the temperature control arrangement may include a liquid heat transfer medium that is maintained at a predetermined, appropriate temperature and continuously circulated into, through and out of an internal, hollow space of a metal substrate, such as a heavy-caliber munitions shell, so as to maintain the shell at stable-state temperature conditions while the molten cladding metal such as nickel is applied to the outer surface of the shell and then solidifies to create the driving band(s). The temperature and flow rate of the liquid heat transfer medium may be determined based on the deposition rate of cladding material, and automatically controlled and appropriately adjusted by a controller such as an electronic control device (ECU) which runs software based programming controls stored in a memory of the ECU. Appropriate temperatures and flow rates of the liquid heat transfer medium based on the deposition rates of the cladding material and/or heat generated by the deposition rates may be pre-determined and stored in the memory of the ECU. Also, appropriate sensors may be used to monitor the temperature of the shell throughout the deposition process, as well as the temperature, pressure, and flow rate of the liquid medium at various points of the Plasma-Arc based deposition system, and the outputs of these sensors are fed to the controller which then effects control of the system, including the temperature control arrangement, in real time in an appropriate manner, e.g., closed loop control.

The liquid heat transfer medium of the temperature control arrangement can be various liquids or liquid solutions, but may vary depending on the appropriate temperature(s) that the hollow casing is to be preheated to and maintained at during the Plasma-Arc deposition process. If the preheat temperature for the hollow substrate and the liquid heat transfer medium temperature is as low as 200° F., water could be used as the liquid heat transfer medium. Further, if cooling, instead of preheating, is needed for pre-adjusting the temperature of a hollow, metal substrate, water would be an ideal heat transfer medium. However, water could be mixed with another substance as the liquid medium, for example a mixture of water with 40% to 50% by volume of glycol could be used as the liquid heat transfer medium, which would increase the boiling point of the liquid medium to about 228° F. Pressurizing the cooling system, as is commonly done in heat transfer systems, will elevate boiling temperature of such a liquid heat transfer medium still further. Neat propylene or ethylene glycol could be used as the liquid heat transfer medium, but these glycols are flammable, so extra safety precautions would be required, e.g., leak detection and prevention, a fire suppression system in the event of accidental ignition, etc. Oils such as Therminol VPI, Therminol 66 and 68, which are used in cooling industrial transformers could be employed as the liquid heat transfer medium if very high preheat temperatures are demanded, as they have boiling points of close to 700° F. Again, safety extra safety precautions would be necessary. Of course, there are many other fluids that could be used as the liquid heat-transfer medium, but the discussed liquids and liquid solutions are commonly used liquid heat-transfer mediums.

The Plasma-Arc based deposition system may also include an pneumatic arrangement in which compressed air or other gas is used to quickly discharge the cooling medium from the hollow metal substrate such as a heavy-caliber munitions shell after the cladding band(s) have been attached to the substrate, so that the productivity of the system is further increased. For example, after cladding metal deposition is complete, the flow and circulation of the liquid medium may be turned off by the controller and then the controller flows a supply of the compressed air or other gas into the hollow substrate to force the liquid medium out of the hollow substrate, after which the metal clad hollow substrate may be removed from the system and another hollow substrate placed into the system for having the metal cladding attached thereto. Such process is repeated continuously or for any desired number of hollow substrates. Depending on the volume of liquid medium to be displaced and its constituents/viscosity, the inventor has determined that it typically takes around one minute to purge the liquid medium from the hollow substrate having the size of a 155 mm caliber shell.

### Intent of Disclosure

Although the following disclosure offered for public dissemination is detailed to ensure adequacy and aid in understanding of the invention, this is not intended to prejudice that purpose of a patent which is to cover each new inventive concept therein no matter how it may later be disguised by variations in form or additions of further improvements. The claims at the end hereof are the chief aid toward this purpose, as it is these that meet the requirement of pointing out the improvements, combinations and methods in which the inventive concepts are found. There has been chosen a specific exemplary embodiment of a plasma arc deposition system according to the invention and specific alternative structures and modifications thereto, the embodiment having been chosen for the purposes of illustration and description of the structure and method of the invention are shown in the accompanying drawings forming a part of the specification.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a schematic view of an exemplary embodiment of a plasma-arc deposition system for depositing metal cladding onto a hollow substrate according to the present invention, with primary focus on a temperature control arrangement of the system.

FIG. 2 is an enlarged cross-sectional view of a hollow substrate of FIG. 1 prior to being filled with a liquid heat transfer medium.

FIG. 3 is an enlarged cross-sectional view of the hollow substrate of FIG. 1 having a rotary, sealing coupling affixed to an end opening of the hollow substrate and the space within the hollow substrate filled with the a liquid heat transfer medium.

FIG. 4 is a flowchart of a cladding process according to an exemplary embodiment of the present invention.

FIG. 5 shows patterns for forming driving band(s) on a hollow metal substrate using conventional welding techniques.

FIG. 6 shows a first technique developed by the inventor for forming driving band(s) on a hollow metal substrate using plasma arc welding techniques.

FIG. 7 shows a second technique developed by the inventor for forming driving band(s) on a hollow metal substrate using plasma arc welding techniques.

FIG. 8 shows a third technique developed by the inventor for forming driving band(s) on a hollow metal substrate using plasma arc welding techniques.

### DETAILED DESCRIPTION OF PRESENTLY CONTEMPLATED EMBODIMENT

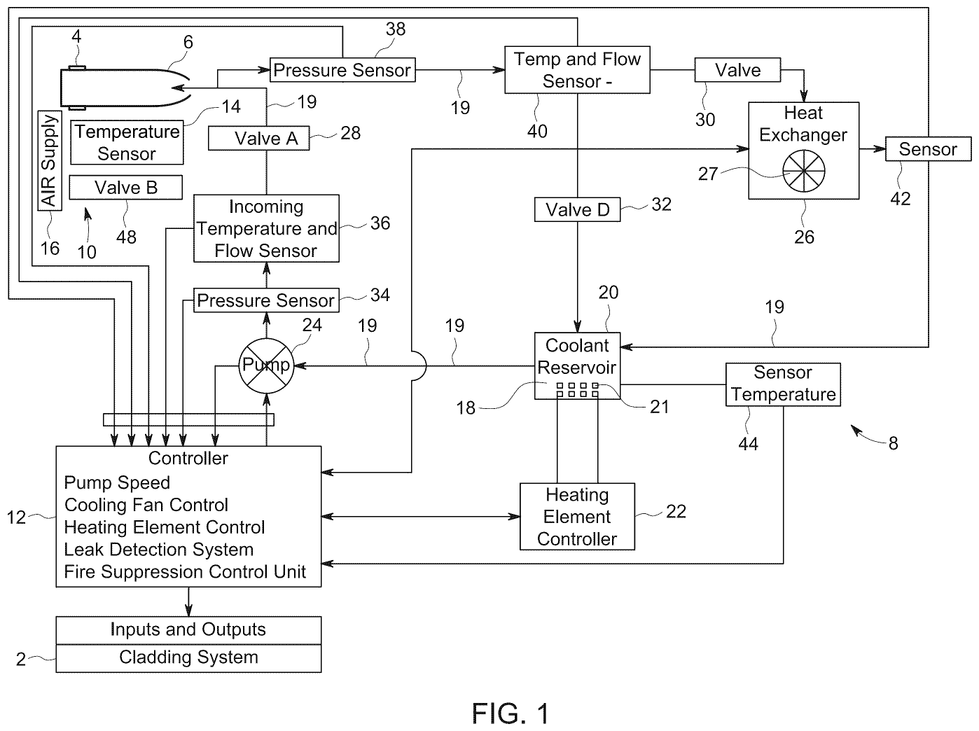

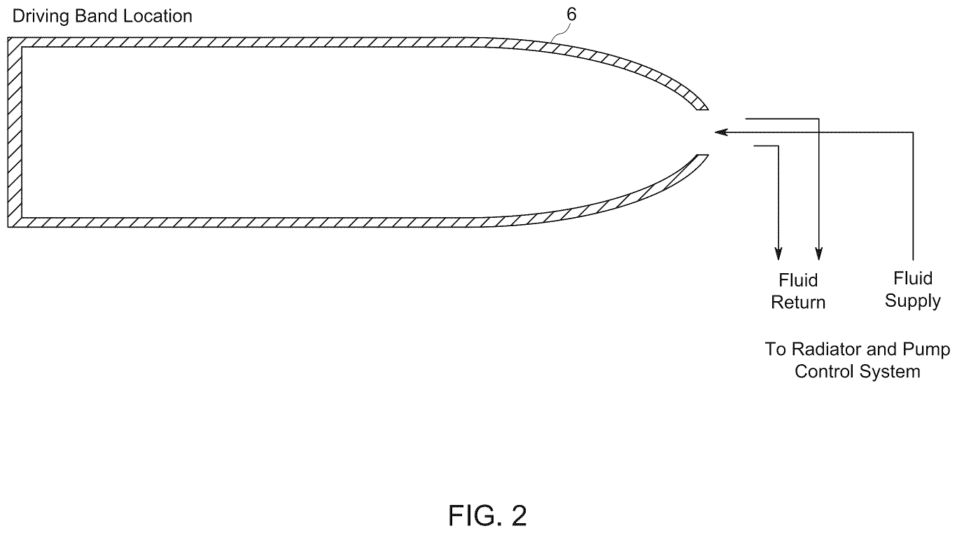

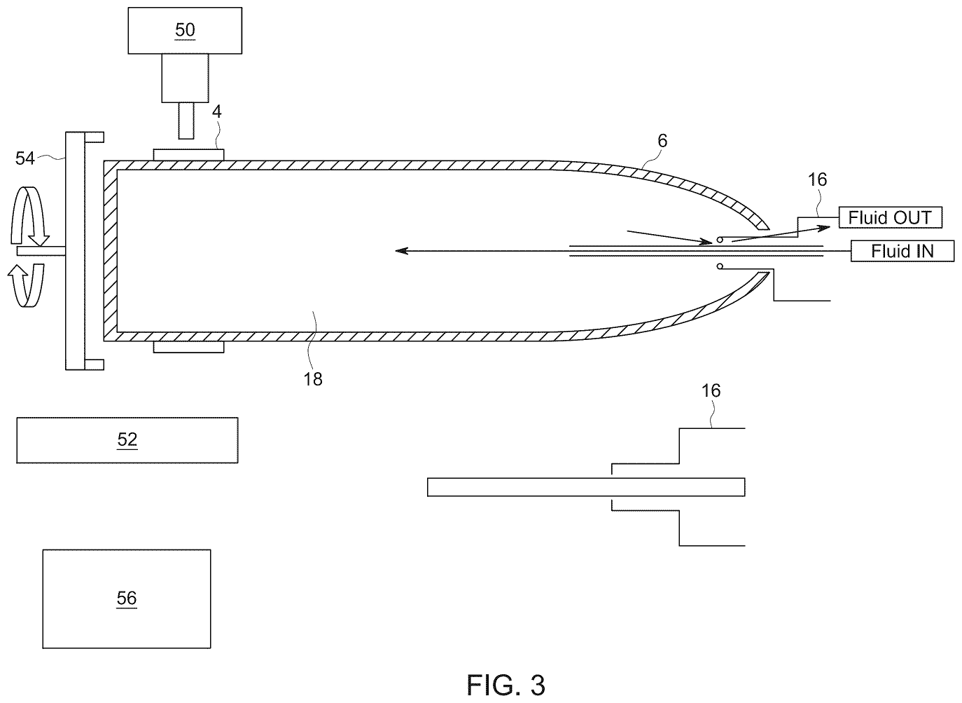

With reference to FIGS. 1-3, there is shown an exemplary embodiment of a plasma-arc deposition system for depositing metal cladding onto a hollow substrate according to the present invention, with primary focus on a temperature control arrangement of the system.

As shown in FIG. 1, the plasma-arc deposition system generally includes: a cladding system 2 which attaches metal cladding 4 to a hollow substrate 6 such as a heavy-caliber munitions shell; a liquid heat transfer medium based temperature control arrangement 8 that maintains temperature of the hollow substrate 6 at appropriate levels throughout a cladding process; a pneumatic arrangement 10 which purges the liquid heat transfer medium from the hollow substrate 6; and a controller 12 such as an electronic control device (ECU) which runs software based programming controls stored in a memory of the ECU to control operations of the plasma-arc deposition system. Appropriate temperatures and flow rates of the liquid heat transfer medium 18 based on the deposition rates of the cladding material and/or heat generated by the deposition rates may be pre-determined and stored in the memory of the ECU 12. The cladding system 2 may include appropriate plasma-arc deposition equipment 50 which is controlled by controller 12 to apply the soft metal cladding 4 around a base portion of the hollow substrate 6 at appropriate deposition rates such as 25 lbs/hr and above, an appropriate system 52 for moving hollow substrates 6 into and out of the plasma-arc deposition, an appropriate device 54 that rotates the hollow substrates during the cladding process and cooperates with a welding head of the plasma-arc deposition equipment 50 that is moved in a predetermined path such that driving band(s) of the appropriate dimensions are applied to the hollow substrates 6 by the plasma process, and a sensor 14 which monitors a surface temperature of the hollow substrate. The sensor 14 may be a surface temperature scanner directed at the exterior surface of the substrate 6 while it is being processed to enable accurate determination of the temperate on the outside of the shell, because in the case where the shell is of considerable thickness, knowing the internal temperature of the liquid medium entering and exiting the substrate 6 may not be accurate enough to enable correct control of dilution of the cladding metal such as nickel and the substrate 6.

The cladding system may also include an oven 56 or other appropriate device for preheating the hollow substrates 6 to desired temperatures.

The liquid heat transfer medium based temperature control arrangement 8 may generally include: a water-tight, rotary coupling 16 that is sealingly fitted into an opening of the hollow substrate 6 during a cladding process that permits a liquid heat-transfer medium 18 such as discussed herein to flow into and out of a space within the hollow substrate and which also permits the hollow substrate to be rotated around its longitudinal axis; piping 19 through which the liquid heat-transfer medium 18 is circulated; a reservoir 20 which contains a supply of the liquid heat-transfer medium 18; a heater 21 which can heat and maintain the liquid heat-transfer medium 18 at appropriate temperatures for the cladding process; a heater controller 22 such as another ECU which runs software based programming controls stored in a memory of the ECU 22 for maintaining the liquid heat-transfer medium 18 in the reservoir 20 at the appropriate temperatures for the cladding operation; a pump 24 which pumps the liquid heat-transfer medium 18 from the reservoir 20 into the hollow substrate 6 during the cladding process; a heat exchanger 26 which can cool the liquid heat-transfer medium 18 after it flows out of the hollow substrate during the cladding process so that the liquid heat-transfer medium 18 may be at an appropriate temperature when it is returned to the reservoir 20; various valves 28-32 provided with the piping 19, such as solenoid controlled valves, that may be selectively opened or closed by the controller 12 as needed during the cladding process; and various temperature, pressure and flow sensors 34-44 which sense the temperature, pressure and flow rate of the liquid heat-transfer medium 18 at various portions of the piping 19 and output sensed values to the controller 12 in real time during the cladding process, which the controller uses to determine appropriate operations of the various components of the system.

The pneumatic arrangement 10 may generally include: a supply of compressed air or other gas 46; and a valve 48 such as solenoid controlled valves that may be selectively opened or closed by the controller 12 as needed to supply the compressed air or gas into the piping 19 so it may flow into the space within the hollow substrate for discharging the liquid heat-transfer medium 18 from the space within the hollow substrate at the end of the cladding process so that the substrate 6 having the cladding attached there to may be replaced with another hollow substrate 6 and the cladding process may be repeated with the other substrate.

### The Cladding Process

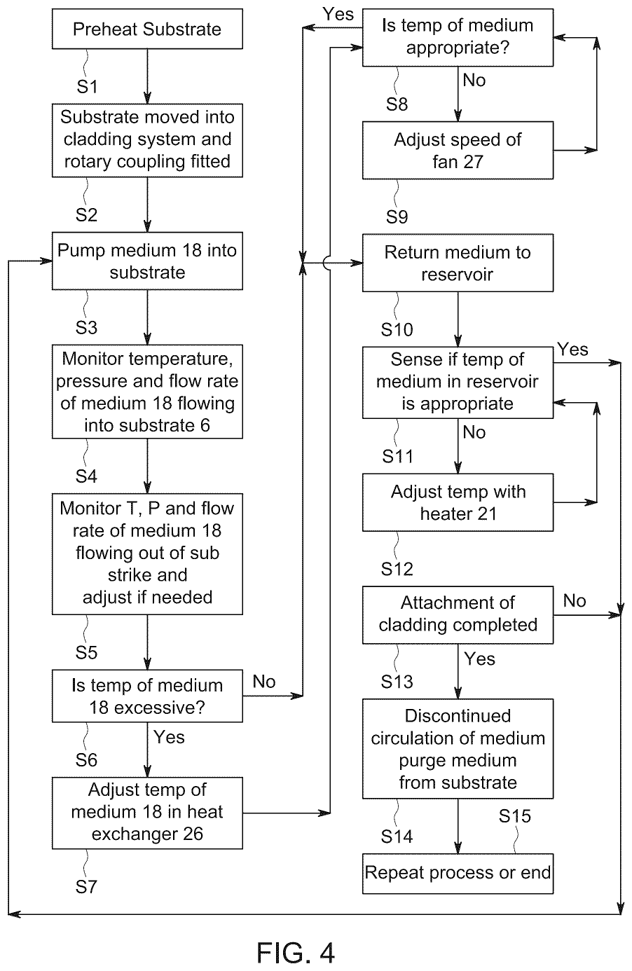

Referring to FIG. 4 there is shown a cladding process for a hollow substrate 6 such as a heavy-caliber munitions shell according to an exemplary embodiment of the present invention. The process may involve preheating of the substrate 6 and maintaining the substrate within acceptable temperature margins despite the rapid application of very high amounts of energy by a plasma arc cladding process.

At step S1 the hollow substrate 6 may be preheated or temperature adjusted to an appropriate temperature. Again, for example, a typical heavy-caliber munitions, 155 mm caliber shell casing. The American Welding Society (AWS) weld standards recommend, but do not require, that before welding or depositing metal on to 4140 steel, the steel should be pre-heated to between 200 and 600° F. such that subsequent cooling rates of the weld/deposit are slowed to a level whereby the risk of cracking of the steel is mitigated. For preheating such casings of 4140 steel can be preheated in an oven to the requisite temperature and then rapidly fixtured in a welding device that applies the driving band and the deposit made while maintaining the correct degree of preheat. Other methods can be used for preheating the 4140 steel casings, as well as other hollow substrates. The preheating step may be omitted if not required.

At step S2 the hollow substrate 6 which may be preheated or not is moved into the plasma-arc deposition system, and the water-tight, rotary coupling 16 is sealingly fitted into an opening of the hollow substrate 6 as a supply/return connection for the liquid heat transfer medium 18. If the substrate 6 is a shell casing of a heavy-caliber munitions, the opening of the hollow substrate may be defined at a “nose” of the shell casing where access to the hollow chamber of the shell is afforded for later filling with explosive and fitment of a detonator. The hollow substrate may be disposed with the rotation device 54 of the cladding system that rotates the shell and moves the welding head of the plasma-arc equipment 52 in a predetermined path such that driving band(s) of the appropriate dimensions are attached to the exterior surface of the substrate by the cladding process.

At step S3 the pump 24 draws the liquid heat transfer medium 18 from the reservoir 20 and flows the liquid medium 18 into the space within the hollow substrate, and this flow is generally continued so as to circulate the liquid medium through the liquid heat transfer medium based temperature control arrangement 8 throughout the cladding process, although the various parameters of the liquid medium 18, including temperature, pressure and flow rate may be adjusted as necessary by the controllers 12, 22 to assure high quality of the clad substrate. The liquid heat transfer medium 18 may be heated by heater 21 which may be disposed inside the reservoir 20 to maintain the medium at an appropriate temperature as controlled by controller 22. The medium 18 should be at a temperature that would reduce the temperature of the hollow substrate 6 having the cladding attached thereto, but is ideally introduced to the substrate at the same temperature as the desired preheat temperature for the substrate.

At step S4, the temperature and pressure and flow rate of liquid heat transfer medium 18 flowing into the substrate are monitored in real time by sensors 34, 36, 44 as elements that enable appropriate control of by the controllers 12, 22, e.g., closed-loop control.

At step S5, the temperature, pressure and flow rate of liquid medium 18 upon exiting the substrate 6 are again monitored and used for process control. A loss of flow on the return line from the substrate 6 could indicate a potentially catastrophic leak of fluid, and should be apparent at the connection to the substrate or the piping 19. Excessive increase in the temperature of the liquid medium 18 could be indicative that flow rate is insufficient to keep the casing temperature within the required boundaries and the control software used by the controller 12 may then increase the pumping speed of the pump 24 such that a higher flow rate of the medium 18 can be made by the controller 12.

At step S6, it is determined whether or not the temperature of the medium 18 is excessive upon exiting the substrate 6.

If the temperature of the medium 18 is determined to be excessive in S6, then at step S7 the liquid medium 18 may pass through the heat exchanger 26 that may include a speed controlled fan 27 directing air through the heat exchanger to cool the liquid medium 18.

At step S8 the temperature of the medium 18 exiting the heat exchanger 26 is again sensed by the sensor 42 and if necessary at step S9 the controller 12 can vary speed of the fan 27 of the heat exchanger 26, or otherwise adjust operation of the heat exchanger, to increase or decrease energy extracted from the medium 18. Control then returns to step S8 to again determine if the temperature of the medium is appropriate and this is repeated until the temperature is appropriate.

At step S10 the liquid medium 18 is returned to the reservoir 20. It is important to ensure that the liquid medium 18 is returned to the reservoir 20 at approximately the same temperature that it exited the reservoir for being pumped to the substrate in step S3.

If the temperature of the medium 18 is determined to be not excessive or already appropriate in S6, then the liquid medium 18 may be directly returned to the reservoir 20 in step S10 without having any temperature adjustment.

At step S11 sensor 44 senses the temperature of the medium in the reservoir so that the controller 22 can determine if it is appropriate or not. If it is not high enough, then at step S12 the controller 22 drives the heater 21 to heat the medium to an appropriate temperature, and the steps S11, S12 are repeated until the temperature of the medium 18 in the reservoir is appropriate. If the temperature of the medium 18 in the reservoir is appropriate then the control returns to step S3 and the flow of the liquid medium 18 continues until the attachment of the cladding 4 to the substrate is completed.

At step S13 it is determined if the cladding process is complete. If No, control returns to step S3. If Yes, then at step S14 operation of the liquid heat transfer medium based temperature control arrangement 8 is terminated by the controller 12 and the controller drives the pneumatic arrangement 10 to purge the liquid heat transfer medium from the hollow substrate 6 using compressed air or other gas. After deposition of the cladding material is completed, the controller 12 turns off the pump 24 and also closes the valve 28 and the valve 30. The controller 12 then opens the valve 48 in a of the pneumatic arrangement 10, along with valve 32, forcing the medium 18 within the substrate 6 outwards and into the piping 19 directly to the fluid reservoir 20. Thus, the pneumatic system 10 is used to drain the substrate 6 and piping 19 of the medium 18 between repeated operations of the cladding process for cladding multiple substrates one at a time. Depending on the volume of medium 18 to be displaced and its constituents/viscosity, it typically occupies around one minute to purge the medium from the substrate, allowing then the rotary coupling 16 to be disconnected from the substrate 6 and the clad substrate ejected from the apparatus in readiness for the next substrate to be processed.

Finally, at step S15 the process is either repeated with another hollow substrate, or terminated. For each cycle of the cladding process the controller 12 resets all the valves 28, 30, 32, 48 to their predetermined appropriate modes (open/closed) before processing begins again.

Effectively, the cladding process of FIG. 4 illustrates how the liquid heat transfer medium of controlled temperature may be continuously circulated through a hollow substrate 6 to maintain stable-state conditions as molten cladding material such as nickel is applied and solidifies to create the driving band(s) 4.

It should be appreciated that safety circuits can be introduced by careful monitoring of the various sensors; a leak of fluid, when detected, could shut down the cladding process, turn off the pump and even activate items such as fire suppression devices and alarm(s).

### Methods for Forming Driving Bands

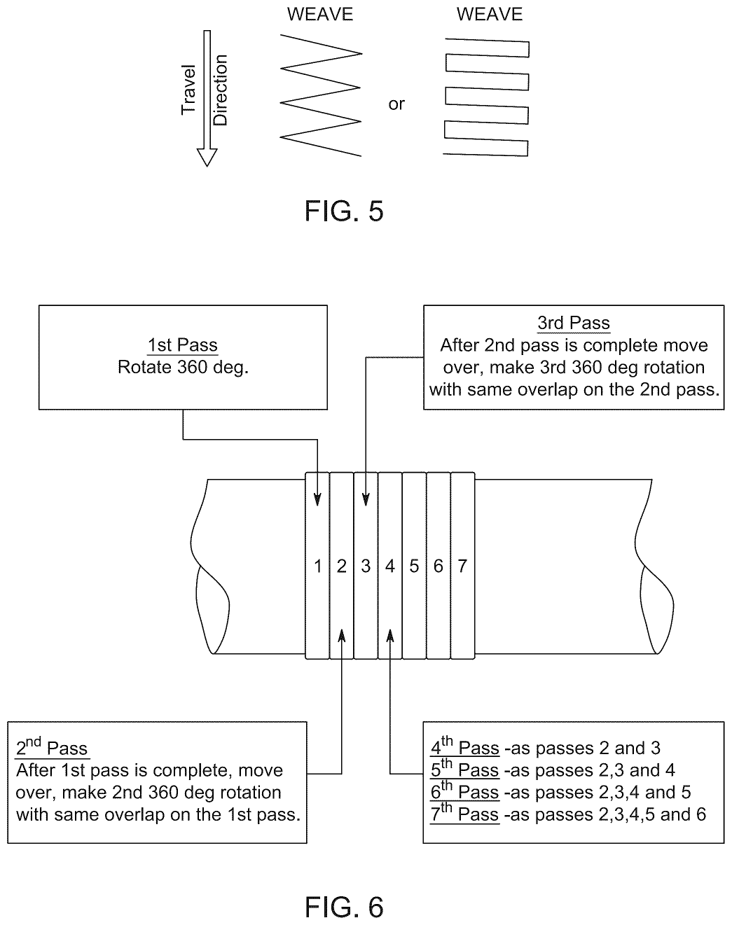

The inventor has investigated methods for forming the driving bands on hollow, steel munitions 155 mm shell casings and has developed multiple appropriate methods which are very advantageous over a conventional method using GMAW welding techniques, as discussed below with reference to FIGS. 5-8. These techniques developed by the inventor may, of course, be applied to hollow metal substrates other than steel munitions 155 mm shell casings.

Referring to FIG. 5, there is shown two typical patterns for forming driving band(s) on a hollow metal substrate using conventional welding techniques. Deposit forming a driving band is conventionally laid down by weaving with a triangular, trapezoidal or square waveform reflected in the patterns. As the deposit is being laid, a shell casing 6 or other hollow metal substrate only rotates once, i.e., 360° +a small overlap, to put, for example, a 2 inch wide “BAND” of Nickel around the circumference of the shell to form the driving band. This method would be a very undesirable technique when using plasma arc welding because it is likely to lead to stress cracking in shell substrate.

Referring to FIG. 6, there is shown one technique developed by the inventor which involves laying down a plurality of more narrow bands, seven narrow bands in this example, which are sequentially formed, adjacent to and slightly overlapping with each other. The shell casing 6 or other hollow metal substrate is rotated 360° when laying down a first band, then the plasma arc welding equipment and/or the shell casing 6 are moved slightly and a second band is laid down with some overlap with the first band as the shell casing 6 is again rotated 360°, and the each of the further bands is then sequentially laid down similarly to the second band. This technique provides much improved results in comparison to the conventional technique shown in FIG. 5, e.g., it is not likely to lead to stress cracking in the metal shell substrate 6.

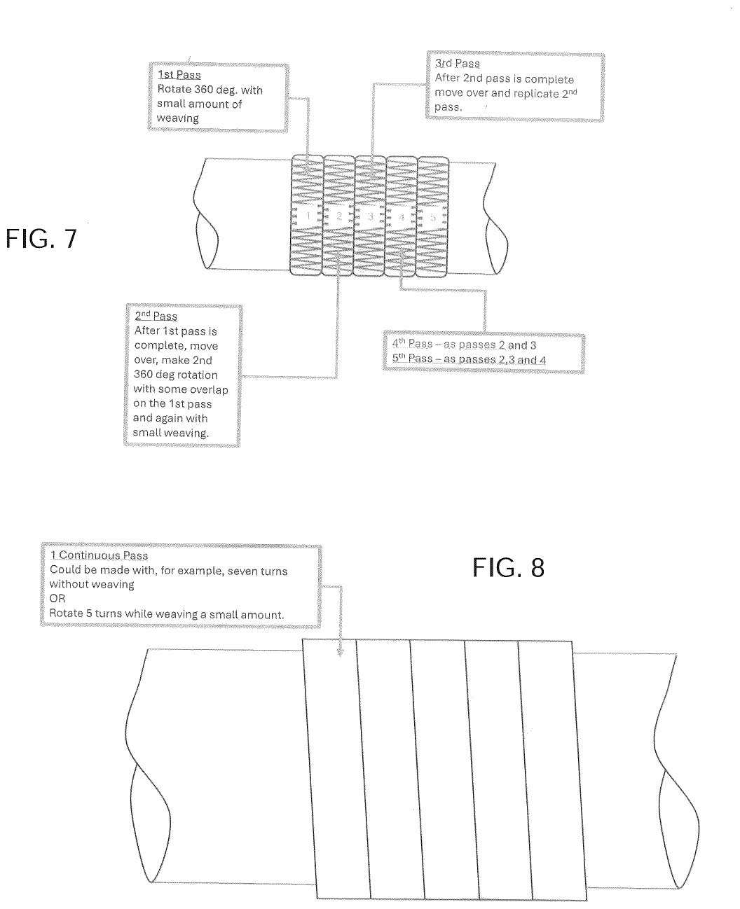

Referring to FIG. 7, there is shown another technique developed by the inventor which is a modification of the technique shown in FIG. 6. This technique involves forming multiple narrower bands similarly to the technique in FIG. 6, and involves laying down a plurality of more narrow bands which are sequentially formed, adjacent to and slightly overlapping with each other, but according to the modification when laying down a band the plasma arc welding equipment is moved in a weaving manner with a triangular, trapezoidal or square waveform similarly to the conventional patterns shown in FIG. 5. Again, the shell casing 6 or other hollow metal substrate is rotated 360° when laying down a first band, then the plasma arc welding equipment and/or the shell casing 6 are moved and a second band is laid down with some overlap with the first band as the shell casing 6 is again rotated 360°, and the each of the further bands is then sequentially laid down similarly to the second band. With this modified technique, the bands may be formed with somewhat greater width than in the technique of FIG. 6 without concern for causing stress cracking of the hollow metal substrate, so that a smaller number of the bands need to be aid down to achieve a desired total band width. This technique also provides much improved results in comparison to the conventional technique shown in FIG. 5, e.g., it is not likely to lead to stress cracking in the metal shell substrate 6.

Referring to FIG. 8, there is shown another technique developed by the inventor which provides the optimum results. With this technique, a plurality of narrower bands, e.g., seven, may be laid down with one continuous pass of the plasma-arc welding equipment as is moved in a helical manner as the shell casing 6 is again rotated 360° when continuously laying down each of the bands. As a modification to this technique, the plasma-arc welding equipments may also be moved in a weaving manner with a triangular, trapezoidal or square waveform similarly to the technique in FIG. 7. Again, the bands laid down in this modified technique may have a somewhat greater width than bands laid down without weaving, so that the total number of bands that need to be laid down to achieve a desired total width is reduced, e.g., 5 bands v. 7 bands, in comparison to this technique which does not involve weaving.

### Example

The inventor has performed experimental operation of the cladding system and process according to the exemplary embodiments of the present invention. For these experiments, the hollow substrates 6 of 4140 steel were clad with nickel without the use of preheat. No cracking of the 4140 steel substrate was observed. However, the present invention is intended to also encompass cladding processes that involve preheating of the hollow substrate such as recommended by the American Welding Society (AWS) weld standards for 4140 steel and other steels and other metal materials, as well as cladding processes that involve initial cooling of the substrate rather than preheating. Further experimentation may be necessary to determine the appropriate conditions for properly cladding any given substrate, whether this involves preheating of the substrate, pre-cooling of the substrate or no preheating or pre-cooling of the substrate for any given metal substrate and any given softer cladding material being applied to the substrate.

The present invention is not limited in its application to the details of construction and to the dispositions of the components set forth in the foregoing description or illustrated in the appended drawings in association with the present exemplary embodiments of the invention. The present invention is capable of other embodiments and of being practiced and carried out in various ways. In addition, it is to be understood that the phraseology and terminology employed herein are for the purposes of illustration and example, and should not be regarded as limiting. For example, while only one substrate 6 is clad at a time in the exemplary embodiment of the cladding process in FIG. 4, the process could be modified such that more than one substrate is clad at a time in the process, which could be effected by adding additional plasma-arc equipment in another parallel arrangement, while the liquid heat transfer medium based temperature control arrangement 8 and the pneumatic arrangement 10 could include additional sensors and/or controllers to properly provide the temperature-controlled liquid medium and the air or other gas for each of the substrates being clad.

As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions.

Although the present invention has been described herein with respect to a specific illustrative embodiment, the foregoing description is intended to illustrate, rather than to limit the invention. Those skilled in the art will realize that many modifications of the preferred embodiment could be made which would be operable. All such modifications are intended to be within the scope and spirit of the present invention.

What is claimed is:

1. A cladding process for depositing metal cladding onto a hollow metal substrate at ultra-high deposition rates while maintaining high quality, comprising steps of:
applying softer metal cladding as at least one annular band around a circumferential periphery of the hollow metal substrate using a plasma-arc welding device;
circulating a liquid heat transfer medium through an interior space of the harder metal, hollow metal substrate such that an outer surface of the substrate to which metal cladding is to be applied is maintained at desired temperatures throughout the cladding applying step; and
controlling temperature of the circulating liquid heat transfer medium to be within a predetermined temperature range;
wherein the hollow metal substrate is formed of a harder metal than the metal cladding.

2. The cladding process according to claim 1, further comprising steps of:
discontinuing the applying and circulating steps when a proper amount of the softer metal cladding has been applied as the at least one annular band around the circumferential periphery of the harder metal, hollow substrate;
purging any of the liquid heat transfer medium from the interior space of the harder metal, hollow metal substrate using a gas; and
repeating the cladding applying, liquid heat transfer medium circulating and temperature controlling steps in relation to another hollow metal substrate.

3. The cladding process according to claim 1, further comprising steps of:
sensing at least temperature of the liquid heat transfer medium flowing into the interior space of the harder metal, hollow metal substrate, temperature of the liquid heat transfer medium flowing out of the interior space of the harder metal, hollow metal substrate, and temperature of the harder metal, hollow metal substrate; and
adjusting at least one of the temperature, pressure and flow rate of the liquid heat transfer medium flowing into the interior space of the harder metal, hollow metal substrate based on the temperatures sensed in the sensing step.

4. The cladding process according to claim 1, wherein the cladding applying step involves forming multiple annular bands directly adjacent to and slightly overlapping with each other along a portion of the hollow metal substrate.

5. The cladding process according to claim 4, wherein the plasma-arc welding device is moved in a weaving manner while forming each of the multiple annular bands.

6. The cladding process according to claim 4, wherein the multiple annular bands are continuously formed on the hollow metal substrate and the plasma-arc welding device is moved in a helical manner as the shell casing 6 is rotated 360° when forming each of the bands.

7. The cladding process according to claim 6, wherein the plasma-arc welding device is moved in a weaving manner while forming each of the multiple annular bands.
